(19) United States
(12) Patent Application Publication
(10) Pub. No.: US 2015/0089425 A1
(43) Pub. Date: Mar. 26, 2015

(54) INFORMATION DENSE USER INTERFACE MECHANICS FOR GEOLOCATION

(71) Applicant: Fisoc, Inc., Austin, TX (US)

(72) Inventors: David H. Fruhling, II, Austin, TX (US); Jay P. Valanju, Austin, TX (US); Daniel Edward Kim, Austin, TX (US); Gerald Alexander Patterson, Austin, TX (US); Brian Rainey, Austin, TX (US)

(21) Appl. No.: 14/300,260

(22) Filed: Jun. 10, 2014

Related U.S. Application Data
(60) Provisional application No. 61/882,112, filed on Sep. 25, 2013.

(51) Int. Cl. G06F 3/0484; G06F 3/0488; G06F 17/30; G06F 3/0481

(52) U.S. Cl. CPC G06F 3/04842; G06F 3/0481; G06F 3/0488; G06F 17/30241
USPC 715/771

(57) ABSTRACT

A graphical user interface is cooperable with geopositioning hardware and software on a user device. The geopositioning hardware and software identify points of interest relative to a current location of the user device according to user-defined search parameters. The graphical user interface includes a geographic summary thumbnail that graphically summarizes distance and direction to a respective one of the points of interest with respect to the current location.

### CROSS-REFERENCES TO RELATED APPLICATIONS

This application claims the benefit of U.S. Provisional Patent Application No. 61/882,112, filed Sep. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to presenting information and, more particularly, to presenting an information dense user interface for geolocation. The invention also relates to a graphical user interface cooperable with geopositioning hardware and software on a user device and a computer system for presenting an information dense user interface.

In touch capable internet devices 100 (FIGS. 1 and 2), screen real estate can sometimes be limited. In the display of geopoints, usually there are two forms of viewing, a list view 130 (FIG. 3) and a map view 110 (FIGS. 1 and 2). The problem with a map view is it is not as user friendly or as dense (with respect to secondary metadata) than a list view.

In the map view 110, usually a map is shown with points of interest rendered as a “pin” 120. These pins can also have an aggregated representation 125 that shows more pins are discoverable when zoomed in. Various additional metadata can be expressed by the color, size, and shape of the pin, but the information can be occluded by the details of the map itself. To get around this, a detailed view 126 can usually be invoked from the map view.

The list view is inherently more scalable in term of its user interface/user experience architecture and its information density, but other than explicitly using distance as metadata, the user loses perspective of other geo information points.

### BRIEF SUMMARY OF THE INVENTION

The solution is to include as metadata a geographic summary thumbnail. This thumbnail provides a summarization of distance and direction of a geopoint with respect to the user's current location.

In an exemplary embodiment, a method for presenting an information dense user interface for geolocation includes the steps of (a) a user device accessing with communication hardware or storing with an onboard memory a database including points of interest; (b) the user device including geolocation hardware for determining a current location of the user device; (c) searching the database with the user device according to user defined parameters and the current location; and (d) displaying search results, wherein the search results include points of interest based on the user defined parameters and the current location, and wherein for each of the points of interest, the search results include a geographic summary thumbnail that graphically summarizes distance and direction with respect to the current location.

The method may further include enabling the user to select the geographic summary thumbnail as an interface affordance to perform a predefined action. An exemplary predefined action is a rendering of a map view centered at the respective point of interest.

Step (d) may be practiced by displaying the geographic summary thumbnail with an arrow or pointer that shows a relative direction of the respective point of interest. The method may also include modifying a parameter of the arrow or pointer to represent other dimensions of data. The modifying step may be practiced by varying a length of the arrow or pointer. The modifying step may be practiced by varying a color of at least one of the geographic summary thumbnail and the arrow or pointer. The other dimensions of data may include a distance to the respective point of interest. Alternatively or additionally, the other dimensions of data may include traffic conditions between the current location and the respective point of interest. Still further, the method may include displaying additional textual or graphical data in a center of the geographic summary thumbnail. In this context, the additional textual or graphical data may include a distance to the respective point of interest. Alternatively or additionally, the additional textual or graphical data may include information pertaining to the respective point of interest.

In another exemplary embodiment, a graphical user interface is cooperable with geopositioning hardware and software on a user device. The geopositioning hardware and software identify points of interest relative to a current location of the user device according to user-defined search parameters. The graphical user interface includes a geographic summary thumbnail that graphically summarizes distance and direction to a respective one of the points of interest with respect to the current location.

In yet another exemplary embodiment, a computer system presents an information dense user interface for geolocation. The computer system includes a processor and communication hardware and an onboard memory communicating with the processor. The computer system accesses a database including points of interest. Geolocation hardware determines a current location of the computer system, and software run by the processor and accessible by the communication hardware or stored in the onboard memory searches the database according to user defined parameters and the current location. A display communicates with the processor, where the processor displays search results on the display, which include points of interest based on the user defined parameters and the current location. For each of the points of interest, the search results include a geographic summary thumbnail that graphically summarizes distance and direction with respect to the current location.

### BRIEF DESCRIPTION OF THE DRAWINGS

These and other aspects and advantages will be described in detail with reference to the accompanying drawings, in which:

FIG. 1 shows a map view including geopoints;

FIG. 2 shows the map view with a detailed view showing metadata relating to a point of interest;

FIG. 3 shows a list view;

FIG. 4 shows a list view including geographic summary thumbnails; and

FIG. 5 is an enlarged view of a geographic summary thumbnail.

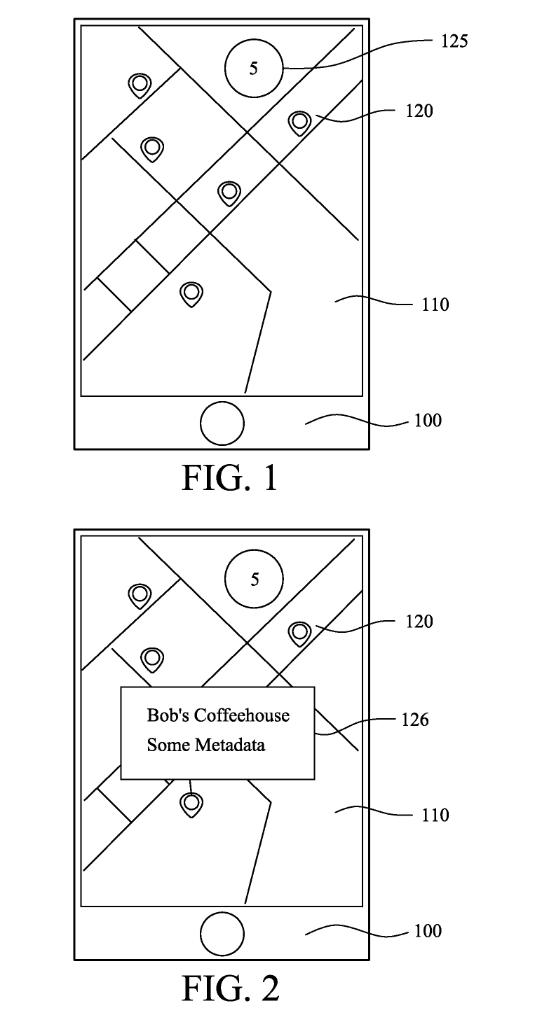

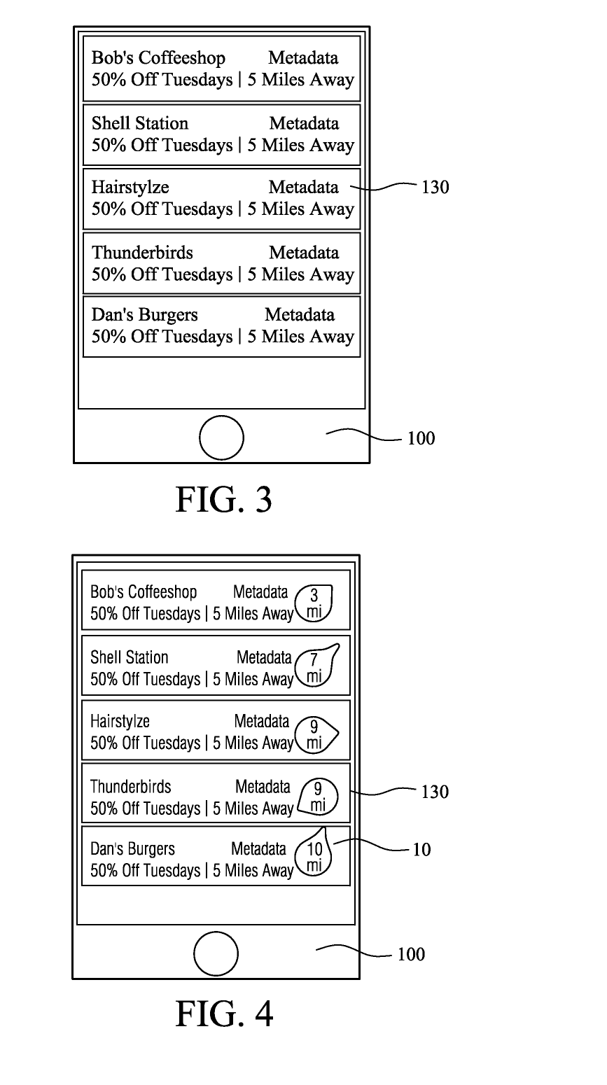

### DETAILED DESCRIPTION OF THE INVENTION

A mobile device comprises a display, a microphone, a speaker, a camera, a high speed transmit/receive device, such as a modem, in addition to a full function keyboard. The display may be touch enabled, touch sensitive, or a touch screen. The device may be multi-touch enabled. The mobile device may have various icons, keys, on-screen keyboards, virtual keyboards, international keyboards, and other aspects which may be integrated into the operating system or downloaded and modified by a server. The mobile device may have additional input/output ports for plugging in auxiliary devices such as a printer, and other devices through either wired or wireless means. The mobile device has a transmitter, receiver, a digital signal processor, other processors, a controller, display electronics and audio/video electronics. These functional blocks may be implemented using standard electronic, mechanical, or electromechanical components or custom electronic, mechanical, or electromechanical components by those knowledgeable in the art.

The mobile device is able to leverage the computing power of a global network or local server to process data. The mobile device serves as a transmit and receive hub. Thus, the mobile device is able to access a network or local server or an intelligent peripheral device to perform any operation or function.

The mobile device is able to transmit data input by a user to the network or local server or other devices for further processing. A user may input data into the mobile device by typing on the keyboard, inputting voice or sound through the mobile device's speaker, touching the screen of the display on the mobile device, using a mouse that interfaces with the mobile device, using a pen that interfaces with the mobile device, or through another method or device that interfaces with the mobile device. This data and commands generated by the mobile device may be sent to the local network server or other devices for further processing. The mobile device is able to retrieve data processed by the local or network server or other devices. The mobile device can then perform further processing or output this data through the display, the speaker, or another device that interfaces with the mobile device.

The mobile device may be configured with several wired and wireless transmit and receive components including, without limitation, 4G, Long term evolution (LTE), 3G, 2G, CDMA, WiMax, NFC, RFID, Global Positioning System (GPS), WiFi, IEEE 802.11a,b,c,n (or any variant), Bluetooth, Zigbee, spread-spectrum, direct sequence spread spectrum (DSSS), frequency division multiplexing (FDM), Orthogonal FDM (OFDM), Ethernet, cable, telephone, USB 1.0, USB 2.0, USB 3.0 or other wired or wireless means. The mobile device may operate on a plurality of frequencies, communication bands, and channels. The mobile device may access location based services. The mobile device may be configured with various software applications that may be run on a server as a software service or are downloaded from the server. Further details relating to the mobile device hardware and software are known and will not be further described.

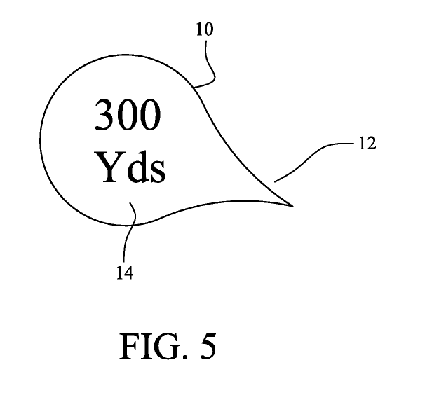

With reference to FIGS. 4 and 5, a geographic summary thumbnail 10 presents metadata relating to a point of interest including a summarization of distance and direction of a geopoint with respect to a user's current location. The thumbnail 10 is composed of a pointer or arrow 12 that shows the relative direction of the point of interest. The arrow 12 can be modified by length or color to represent other dimensions of data (such as distance or traffic conditions). The real estate 14 in the center of the geographic summary thumbnail 10 may provide additional textual or graphical information. The information can be dynamic depending on context. For example, this area 14 can be used for distance calculations or open or closed status of the point of interest.

The geographic summary thumbnail 10 may also act as an interface affordance to go to a map view centered on that point or some other arbitrary action. Examples or arbitrary actions include, without limitation, book a reservation, generate a list of directions, book transport to the subject location, etc.

In order to present an information dense user interface for geolocation, the user device accesses a database including points of interest. The user device may access the internet with suitable communication hardware or the like, or the user device may store the database of points of interest on an onboard memory. The user device includes geolocation hardware, such as GPS or the like, for determining a current location of the user device. A processor in the user device searches the database according to user defined parameters and the current location. In displaying the search results, the search results include points of interest based on the user defined parameters and the current location. For each of the points of interest, the search results include a geographic summary thumbnail 10 that graphically summarizes distance and direction with respect to the current location.

With the displayed geographic summary thumbnails, the user can select one of the geographic summary thumbnails as an interface affordance to perform a predefined action. For example, the action may include rendering a map view centered at the respective point of interest. As noted, displaying the geographic summary thumbnail may include an arrow or pointer that shows a relative direction of the respective point of interest.

The geographic summary thumbnail of the described embodiments provides for increased information density for a geolocation. The thumbnail graphically summarizes distance and direction of points of interest with respect to a user's current location.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for presenting an information dense user interface for geolocation, the method comprising:
(a) a user device accessing with communication hardware or storing with an onboard memory a database including points of interest;
(b) the user device including geolocation hardware for determining a current location of the user device;
(c) searching the database with the user device according to user defined parameters and the current location; and
(d) displaying search results, wherein the search results include points of interest based on the user defined parameters and the current location, and wherein for each of the points of interest, the search results include a geographic summary thumbnail that graphically summarizes distance and direction with respect to the current location.

2. A method according to claim 1, further comprising enabling the user to select the geographic summary thumbnail as an interface affordance to perform a predefined action.

3. A method according to claim 2, wherein the predefined action comprises rendering a map view centered at the respective point of interest.

4. A method according to claim 1, wherein step (d) is practiced by displaying the geographic summary thumbnail with an arrow or pointer that shows a relative direction of the respective point of interest.

5. A method according to claim 4, further comprising modifying a parameter of the arrow or pointer to represent other dimensions of data.

6. A method according to claim 5, wherein the modifying step is practiced by varying a length of the arrow or pointer.

7. A method according to claim 5, wherein the modifying step is practiced by varying a color of at least one of the geographic summary thumbnail and the arrow or pointer.

8. A method according to claim 5, wherein the other dimensions of data comprise a distance to the respective point of interest.

9. A method according to claim 5, wherein the other dimensions of data comprise traffic conditions between the current location and the respective point of interest.

10. A method according to claim 4, further comprising displaying additional textual or graphical data in a center of the geographic summary thumbnail.

11. A method according to claim 10, wherein the additional textual or graphical data comprises a distance to the respective point of interest.

12. A method according to claim 10, wherein the additional textual or graphical data comprises information pertaining to the respective point of interest.

13. A graphical user interface cooperable with geopositioning hardware and software on a user device, the geopositioning hardware and software identifying points of interest relative to a current location of the user device according to user-defined search parameters, the graphical user interface comprising a geographic summary thumbnail that graphically summarizes distance and direction to a respective one of the points of interest with respect to the current location.

14. A graphical user interface according to claim 13, wherein the geographic summary thumbnail comprises an arrow or pointer that shows a relative direction of the respective point of interest.

15. A graphical user interface according to claim 14, wherein a parameter of the arrow or pointer is modified to represent other dimensions of data.

16. A graphical user interface according to claim 15, wherein the parameter is modified by varying a length of the arrow or pointer.

17. A graphical user interface according to claim 15, wherein the parameter is modified by varying a color of at least one of the geographic summary thumbnail and the arrow or pointer.

18. A graphical user interface according to claim 15, wherein the other dimensions of data comprise a distance to the respective point of interest.

19. A graphical user interface according to claim 15, wherein the other dimensions of data comprise traffic conditions between the current location and the respective point of interest.

20. A graphical user interface according to claim 4, further comprising additional textual or graphical data in a center of the geographic summary thumbnail.

21. A graphical user interface according to claim 20, wherein the additional textual or graphical data comprises a distance to the respective point of interest.

22. A graphical user interface according to claim 20, wherein the additional textual or graphical data comprises information pertaining to the respective point of interest.

23. A computer system for presenting an information dense user interface for geolocation, the computer system comprising:
a processor;
communication hardware and an onboard memory communicating with the processor, the computer system accessing via the communication hardware or storing in the onboard memory a database including points of interest;
geolocation hardware for determining a current location of the computer system;
software run by the processor and accessible by the communication hardware or stored in the onboard memory that searches the database according to user defined parameters and the current location; and
a display communicating with the processor, the processor displaying search results on the display, wherein the search results include points of interest based on the user defined parameters and the current location, and wherein for each of the points of interest, the search results include a geographic summary thumbnail that graphically summarizes distance and direction with respect to the current location.

24. A computer system according to claim 23, wherein the geographic summary thumbnail comprises an arrow or pointer that shows a relative direction of the respective point of interest.

25. A computer system according to claim 24, wherein a parameter of the arrow or pointer is modified to represent other dimensions of data.

26. A computer system according to claim 25, wherein the parameter comprises a length of the arrow or pointer.

27. A computer system according to claim 25, wherein the parameter comprises a color of at least one of the geographic summary thumbnail and the arrow or pointer.
